(19) United States
(12) Patent Application Publication
(10) Pub. No.: US 2014/0201262 A1
(43) Pub. Date: Jul. 17, 2014

(54) USER DEVICE, COMMUNICATION SERVER AND CONTROL METHOD THEREOF

(71) Applicant: Samsung Electronics Co., Ltd., Suwon-si (KR)

(72) Inventors: Hong-uk WOO, Seoul (KR); Hong-soo KIM, Seoul (KR); Kyu-sik KIM, Seoul (KR); Dong-kyoung KIM, Suwon-si (KR)

(73) Assignee: Samsung Electronics Co., Ltd., Suwon-si (KR)

(21) Appl. No.: 14/093,265

(22) Filed: Nov. 29, 2013

(30) Foreign Application Priority Data
Jan. 16, 2013 (KR) 10-2013-0004919

(51) Int. Cl. H04L 29/06

(52) U.S. Cl. CPC H04L 67/42
USPC 709/203

(57) ABSTRACT

User devices, a communication server and a control method are provided. The control method of the user devices includes registering the user devices to a communication server that provides a service of a virtual device network, receiving a virtual Internet Protocol (IP) address of a counterpart device included in the virtual device network from the communication server, determining whether an application attempts to perform data communication with the counterpart device using the virtual IP address, and performing the data communication with the counterpart device according to information provided from the communication server if the application attempts to perform data communication with the counterpart device using the virtual IP address.

### CROSS-REFERENCE TO RELATED APPLICATION

This application claims the benefit of a Korean patent application filed on Jan. 16, 2013 in the Korean Intellectual Property Office and assigned Serial No. 10-2013-0004919, the entire disclosure of which is hereby incorporated by reference.

### BACKGROUND

1. Field of the Invention

Apparatuses and methods consistent with the exemplary embodiments of the present disclosure relate to a user device, a communication server and a control method thereof. More particularly, the apparatuses and methods consistent with the exemplary embodiments of the present disclosure relate to a user device, a communication server and a control method thereof, in which service provided through a network is used for data communication.

2. Description of the Related Art

In the related art, a lot of applications and services are provided to synchronize user devices connected to one networking subnet, for example, by using one Wi-Fi router or one Local Area Network (LAN) subnet. Specifically, in a case having an application for synchronization between a Personal Computer (PC) and a mobile device, one device which is to connect with a counterpart device sets up an explicit Internet Protocol (IP) address of the counterpart device.

Meanwhile, for example, many group-based real-time applications of an Android™ application market, or of any similar application markets, allow communication between user devices on a server-less setup within one subnet. However, even in such an application, network server components, such as device management, a directory service, group management, and the like, are used for real-time remote communication between user devices that belong to different subnets.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a user device, a communication server and a control method thereof, in which real-time remote communication is possible regardless of a subnet in which the user devices belong.

Another aspect of the present disclosure is to provide a user device, a communication server and a control method thereof, in which real-time remote communication is possible between the user devices without changing the existing application.

In accordance with an aspect of the present disclosure, a control method of user devices is provided. The control method of the user devices includes registering the user devices to a communication server that provides a service of a virtual device network, receiving a virtual Internet Protocol (IP) address of a counterpart device included in the virtual device network from the communication server, determining whether an application attempts to perform data communication with the counterpart device using the virtual IP address, and performing the data communication with the counterpart device according to information provided from the communication server if the application attempts to perform data communication with the counterpart device using the virtual IP address.

In accordance with an aspect of the present disclosure, a user device is provided. The user device includes a communication section communicating with a communication server that provides a service of a virtual device network, a user input section receiving a user input of an instruction, and a controller registering the user device to the communication server that provides the service of the virtual device network in accordance with a user's instruction, receives a virtual IP address of a counterpart device included in the virtual device network from the communication server, determining whether an application attempts to perform data communication with the counterpart device through the virtual IP address, and performing the data communication with the counterpart device according to information provided from the communication server if the application attempts to perform data communication with the counterpart device using the virtual IP address.

In accordance with an aspect of the present disclosure, a control method of a communication server is provided. The method includes registering a plurality of user devices with respect to a service of a virtual device network, transmitting respective virtual IP addresses of two or more user devices, which are to participate in the virtual device network, from among the plurality of registered user devices to the user devices, and providing information for data communication between the two or more user devices.

In accordance with an aspect of the present disclosure, a communication server is provided. The communication server includes a communication section communicating with a plurality of user devices, and a controller registering the plurality of user devices with respect to a service of a virtual device network, transmitting respective virtual IP addresses of two or more user devices, which are to participate in the virtual device network, from among the plurality of registered user devices to the user devices, and providing information for data transmission between the two or more user devices.

Other aspects, advantages, and salient features of the present disclosure will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present disclosure will be more apparent from the following description taken in conjunction with the accompanying drawings, in which:

FIG. 1 illustrates a communication server and a user device according to an exemplary embodiment of the present disclosure;

FIG. 2 illustrates a configuration of a communication server according to an exemplary embodiment of the present disclosure;

FIG. 3 is a flowchart showing operations of a communication server according to an exemplary embodiment of the present disclosure;

FIG. 4 illustrates a software architecture of a controller in a communication server according to an exemplary embodiment of the present disclosure;

FIG. 5 illustrates a configuration of a user device according to an exemplary embodiment of the present disclosure;

FIG. 6 is a flowchart showing operations of a user device according to an exemplary embodiment of the present disclosure;

FIG. 7 illustrates a software architecture of a controller in a user device according to an exemplary embodiment of the present disclosure;

FIG. 8 illustrates interactive operations between a communication server and a user device according to an exemplary embodiment of the present disclosure;

FIG. 9 illustrates detailed operations of a user device according to an exemplary embodiment of the present disclosure; and

FIG. 10 illustrates operations of a Virtual Device Network (VDN) application and interactive operations between an application and a virtual adapter according to an exemplary embodiment of the present disclosure.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present disclosure is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

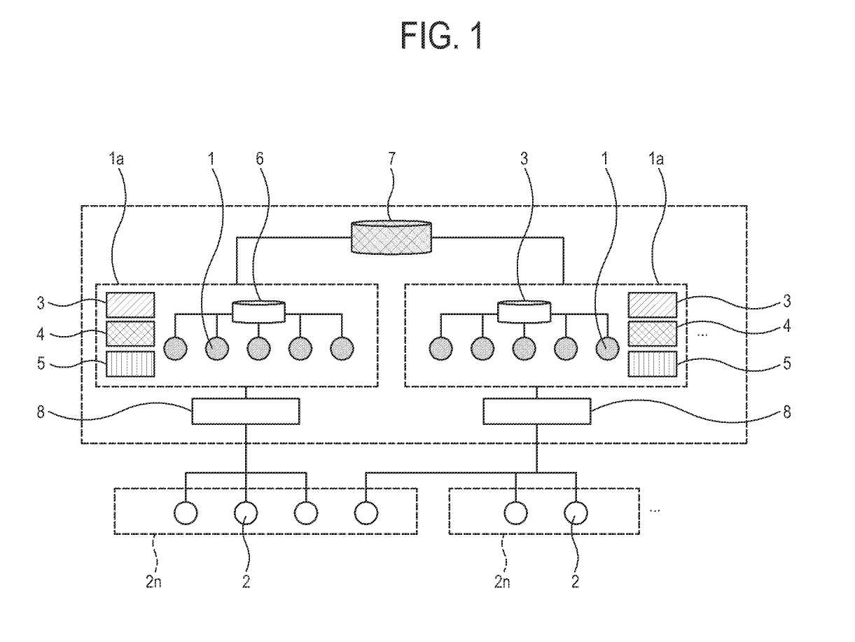

FIG. 1 illustrates a communication server and a user device according to an exemplary embodiment of the present disclosure.

Referring to FIG. 1, a communication server 1 connects with a user device 2 and/or a plurality of the user devices 2 through a network. The network for connection between the communication server 1 and the user device 2 includes a wired network and/or a wireless network, for example, a Local Area Network (LAN), a 3^{rd} Generation (3G) network, a Wireless Fidelity (Wi-Fi) network, or any other similar and/or suitable wired and/or wireless network type. The communication server 1 provides data transmission services between a plurality of user devices 2. The communication server 1 generates a virtual device network 2n between the plurality of user devices 2, thereby providing the data transmission services.

Further, an authentication server 3 providing an authentication service of the user device 2, a signaling server 4 providing a signaling interface for data transmission between the plurality of user devices 2, a relay server 5 relaying data between the plurality of user devices 2, a local session DataBase (DB) 6 storing information about the virtual device network 2n, and other similar and/or suitable information, may be used to provide the service for the virtual device network 2n. Here, at least one of the authentication server 3, the signaling server 4, the relay server 5, the local session DB 6, or any other similar and/or suitable element may be provided in the communication server 1.

A plurality of communication servers 1s (not shown) may be provided. Also, one or more communication server 1 may be provided in each of a plurality of zones 1a. In this case, a global session DB 7 between the plurality of zones 1a may be used. In the service for the virtual device network 2n, a load balancer 8 may further be used for controlling traffic between a plurality of networks.

The plurality of user devices 2 may perform interactive data transmission there between through the service provided from the communication server 1. The data transmission between the plurality of user devices 2 may be achieved in real time. The virtual device network 2n may be generated as two or more of the plurality of user devices 2 to be used for the data transmission from among the plurality of user devices 2 that may voluntarily participate therein according to a user's intention. Two or more of the plurality of user devices 2 performing the data transmission on the virtual device network 2n may belong to one subnet or different subnets.

The user device 2 participating in the virtual device network 2n is allocated a static virtual Internet Protocol (IP) address, which may be referred to as a virtual IP, by the communication server 1. Using the allocated virtual IP, the user device 2 performs the data transmission to another user device 2, which may be referred to as a counterpart device 2, on the virtual device network 2n.

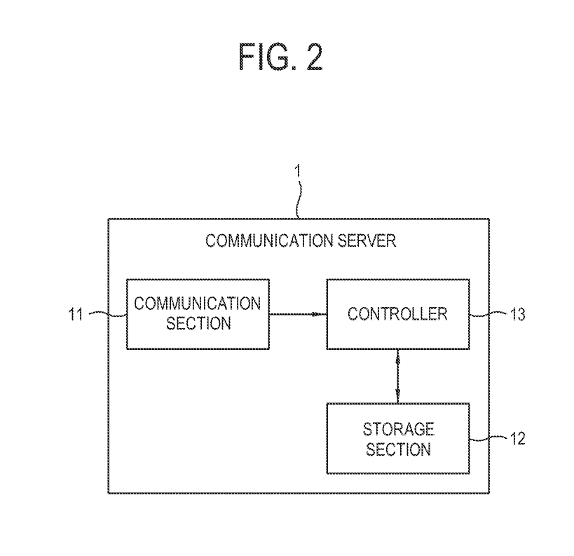

FIG. 2 illustrates a configuration of a communication server according to an exemplary embodiment of the present disclosure.

Referring to FIG. 2, the communication server 1 may include a communication section 11, a storage section 12, and a controller 13. The communication section 11 is connected to the network as a network interface, and performs communication under control of the controller 13. The storage section 12 may be a nonvolatile memory, such as a hard disk drive, a flash memory, or any other similar and/or suitable nonvolatile storage medium, which stores information and data used for providing services. The controller 13 performs general control of the services of the virtual device network 2n.

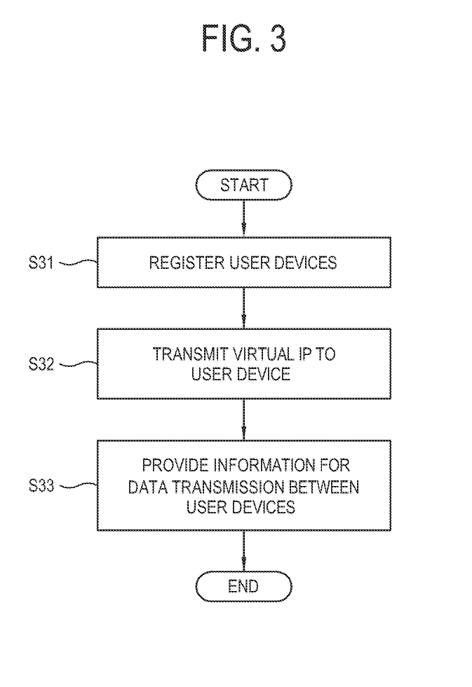

FIG. 3 is a flowchart showing operations of a communication server according to an exemplary embodiment of the present disclosure.

Referring to FIG. 3, at operation S31, the controller 13 registers the plurality of user devices 2 with regard to services of the virtual device network 2n. Next, at operation S32, the controller 13 controls that the virtual IPs of two or more of the plurality of user devices 2 that are to participate in the virtual device network 2n, from among the plurality of registered user devices 2, are transmitted to the user device 2. Next, at operation S33, the controller 13 provides the user device 2 with information about data transmission between two or more plurality of user devices 2. For the service of the virtual device network 2n, the controller 13 may provide functions, such as instant messaging, presence, multiple chatting, voice/video call, collaboration, routing of Extensible Markup Language (XML) data, or other similar and/or suitable functions, through an eXtensible Messaging and Presence Protocol (XMPP).

The controller 13 of the communication server 1 may be achieved by hardware and/or a hardware device and/or element, such as a microprocessor, a controller, a processor, an Integrated Circuit (IC), or any other similar and/or suitable hardware element and software (e.g., a control program) to be executed by the hardware element. The controller 13 may include a nonvolatile memory such as a Random Access Memory (RAM), or any other similar and/or suitable nonvolatile memory capable of temporarily storing a control program.

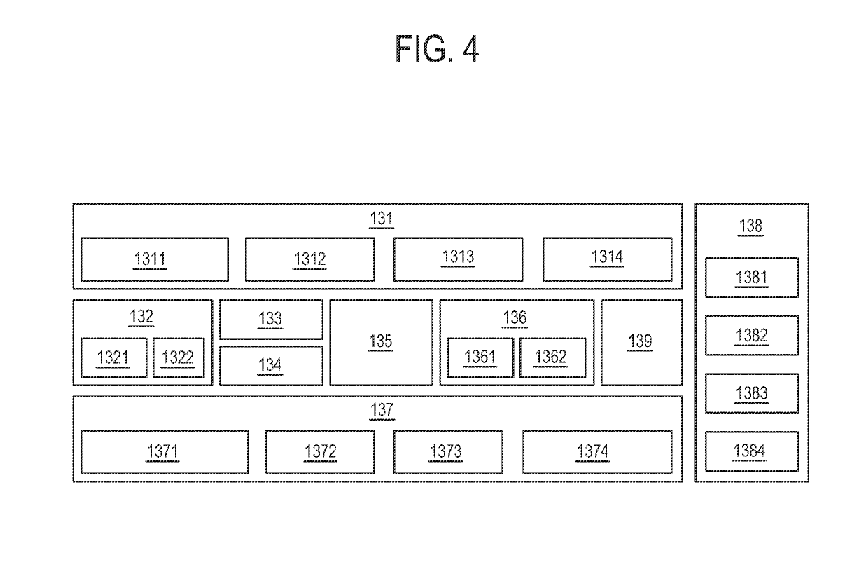

FIG. 4 illustrates a software architecture of a controller in a communication server according to an exemplary embodiment of the present disclosure.

Referring to FIG. 4, a control program of the controller 13 may include a messenger manager 131, a security manager 132, a group manager 133, a roster manager 134, a presence manager 135, a session manager 136, a virtual IP manager 139, a connection manager 137 and a data manager 138. The messenger manager 131 handles an XMPP stanza. The messenger manager 131 may include a message handler 1311 for handling a message, an Info/Query (IQ) handler 1312 for handling IQ, a presence handler 1313 for handing the presence, and a push gateway 1314. The security manager 132 may include an authentication component 1321 for performing authentication, and a Secure Socket Layer (SS1)/Transport Layer Security (TLS) component 1322 for supporting an SSL/TLS mechanism between the user device 2 as a client and the communication server 1 for channel encryption. The group manager 133 manages group community functions such as creation, deletion, participation, and other similar and/or suitable functions of the virtual device network 2n. The roster manager 134 manages a roster information, such as a buddy list, a contact list, or other similar and/or suitable information of the plurality of user devices 2 participating in the virtual device network 2n. The presence manager 135 manages presence information indicating whether communication of each user device 2 is enabled or not, so as to manage status information. The session manager 136 may manage session information, and may include a session management component 1361 and a routing management component 1362. The virtual IP manager 139 manages the virtual IP for the service of the virtual device network 2n. The connection manager 137 may manage a connection between the communication server 1 and the user device 2, and may include a socket handler 1371, a receiver 1372, a listener 1373 and a channel handler 1374. The data manager 138 manages data of a session 1381, a roster 1382, a virtual IP 1383 and routing 1384.

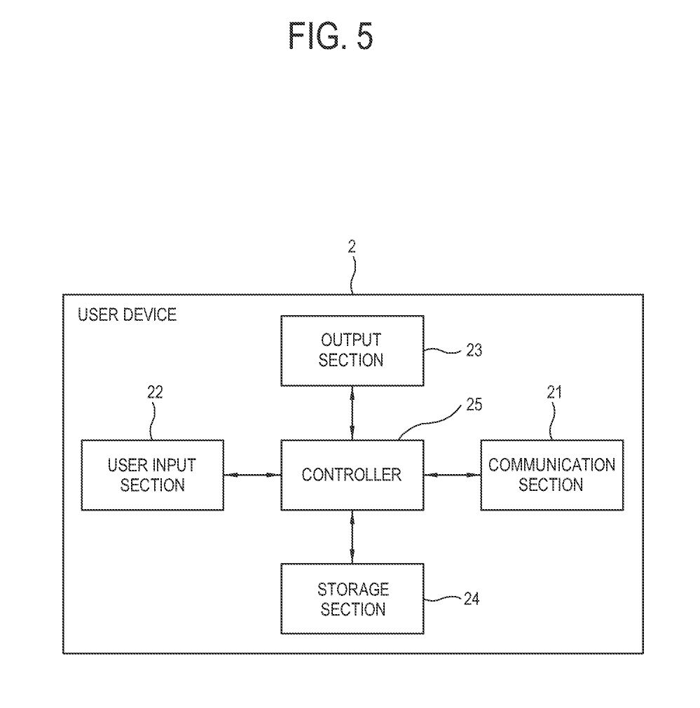

FIG. 5 illustrates a configuration of a user device according to an exemplary embodiment of the present disclosure.

Referring to FIG. 5, the user device 2 may include a communication section 21, a user input section 22, an output section 23, a storage section 24, and a controller 25. The communication section 21 is connected as a network interface to the network and performs communication under control of the controller 25. The user input section 22 receives a user's instruction. The controller 25 performs general control for data transmission to the counterpart device 2 through the virtual device network 2n.

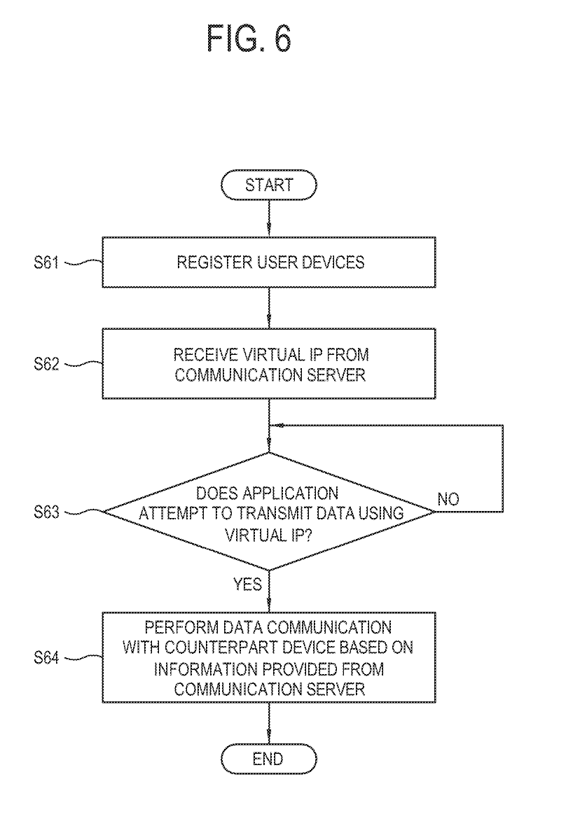

FIG. 6 is a flowchart showing operations of a user device according to an exemplary embodiment of the present disclosure.

Referring to FIG. 6, at operation S61, the controller 25 registers the user device 2 to the communication server 1 in accordance with a user's instruction. Next, at operation S62, the controller 25 controls that the virtual IP of the counterpart device 2 included in the virtual device network 2n is received from the communication server 1. Next, at operation S63, the controller 25 determines whether the application uses the virtual IP when attempting to perform data communication with the counterpart device 2 by attempting to transmit data through using the virtual IP. If there is an attempt, then at operation S64 the controller 25 controls the data communication with the counterpart device 2 based on information provided from the communication server 1.

Referring back to FIG. 5, the storage section 24 of the user device 2 may include a nonvolatile memory, such as a hard disk drive, a flash memory, or any other similar and/or suitable nonvolatile storage medium, and may store data and information used for data communication with the counterpart device 2, and the output section 23 of the user device 2 may output a processing result based on the transmitted data. The output section 23 may include at least one of a display, such as an Organic Light Emitting Diode (OLED) display, a Liquid Crystal Display (LCD), or any other similar and/or suitable display device, for outputting video data and a speaker for outputting audio data as the processing result.

The controller 25 of the user device 2 may be achieved by hardware such as a microprocessor, a controller, an IC, or any other similar and/or suitable type of hardware element, and software, such as a control program, an Application Program Interface (API), an application, or any other similar and/or suitable software to be executed by the hardware element. The controller 25 may include a volatile memory such as a Random Access Memory (RAM) capable of temporarily storing the control program or the like.

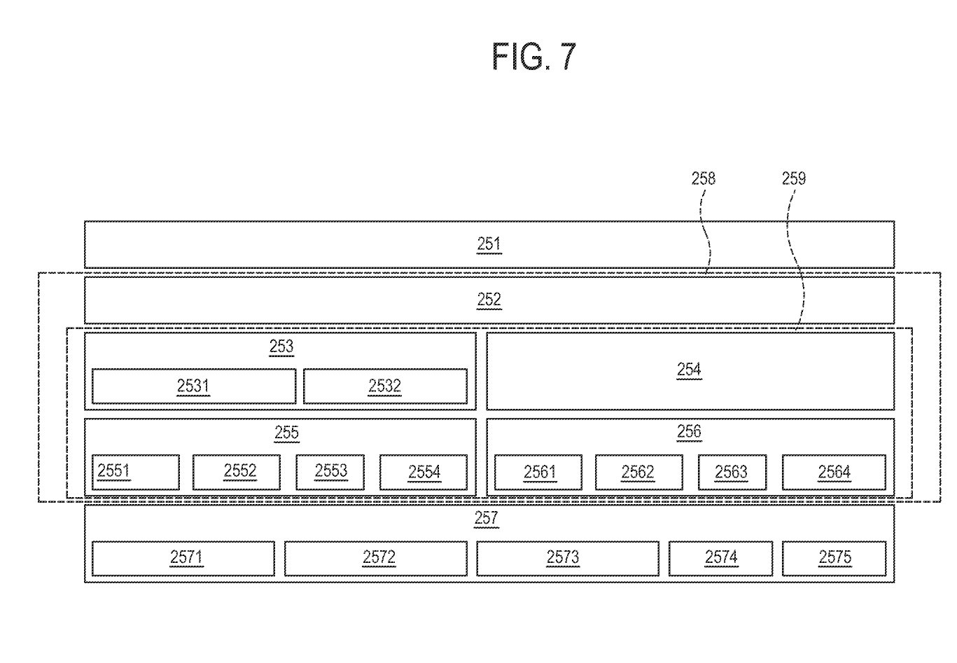

FIG. 7 illustrates a software architecture of a controller in a user device according to an exemplary embodiment.

Referring to FIG. 7, the controller 25 of the user device 2 may include an application 251, an API 252, a security manager 253, a session manager 254, a communication manager 255, a connection manager 256 and a connection handler 257. The application 251 includes any program that may be used by a user, and for example may be a game application, a file transmission application, a remote control application, or any other similar and/or suitable application. The API 252 provides a subroutine or function that may be invoked by the application 251 to request the security manager 253 or the like to perform a predetermined process. The security manager 253 may include an authentication component 2531 for performing authentication, and an SSL/TLS component 2532 supporting an SSL/TLS mechanism between the communication server 1 and the user device 2 for the channel encryption. The session manager 254 supports a session function between the communication server 1 and the user device 2 or between the communication server 1 and the plurality of user devices 2. The communication manager 255 provides functions such as messaging 2551, presence 2552, roster 2553 and multiple communication 2554. The connection manager 256 supports connection handling between the communication server 1 and the user device 2 or between the communication server 1 and the plurality of user devices 2. The connection manager 256 may include a Peer to Peer (P2P) negotiator 2561 for setting up an interactive connection between the plurality of user devices 2, a relay handler 2562 for enabling data transmission through the relay server 5, a Network Address Translator (NAT) traversal component 2563 for enabling NAT traversal through a User Datagram Protocol (UDP) hole punching or the like, and a virtual device network handler 2564 for handling and constructing the virtual device network 2n through the virtual IP. The connection handler 257 manages a connection between the user device 2 and the communication server 1. The connection handler 257 may include a socket handler 2571, a virtual adapter 2572, a virtual IP interface 2573, a receiver 2574 and a listener 2575. The virtual adapter 2572 is a component for achieving the virtual device network 2n between the plurality of user devices 2. The virtual IP interface 2573 is a physical interface which is used for allocating one or more addresses to the system without binding the addresses. In the exemplary embodiment of FIG. 7, a Virtual Device Network (VDN) client 258 may include the Application Programming Interface (API) 252, the security manager 253, the session manager 254, the communication manager 255 and the connection manager 256. In the exemplary embodiment of FIG. 7, a VDN application 259 may include the security manager 253, the session manager 254, the communication manager 255 and the connection manager 256.

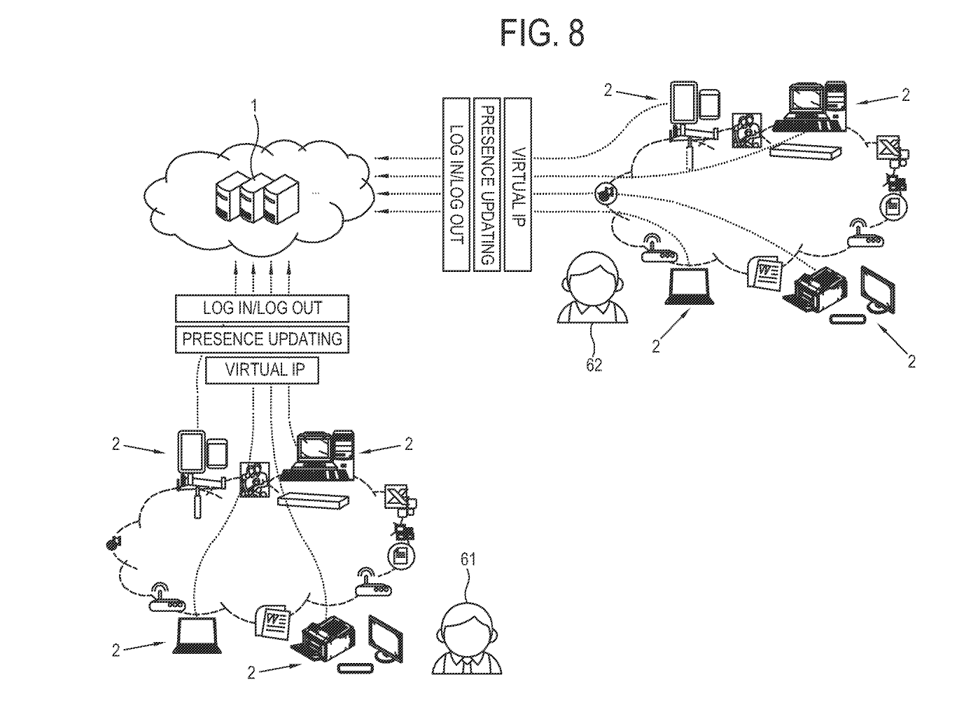

FIG. 8 illustrates interactive operations between a communication server and a user device according to an exemplary embodiment of the present disclosure.

Referring to FIG. 8, two or more of the plurality of user devices 2, from among the plurality of user devices 2, may constitute the virtual device network. The virtual device network may be configured by one or both of a user device 2 of a first user 61 and a user device 2 of a second user 62. Each of the plurality of user devices 2 may be any of various electronic devices such as a laptop computer, a notebook computer, a Personal Computer (PC), a cellular phone, a smart phone, a smart pad, a mobile terminal, a television, an audio system, a home appliances, a facsimile machine, a printer or a business machines, or any other similar and/or suitable electronic device. For example, a place where the plurality of user devices 2 is provided may be a home, an office, a coffee shop, an exterior area, an interior area, or any other similar and/or suitable area having electronic devices. Within a virtual device network 2n (see FIG. 1), the plurality of user devices 2 may exchange data with each other. Data transmitted and received through the virtual device network 2n may include data for a game, a file, such as a document or the like), multimedia contents, such as video data, audio data or similar and/or suitable multimedia data, and/or any other similar and/or suitable data and information for various purposes or formats. The user device 2 may be connected to a home network, an office LAN, a 3G network, or any other similar and/or suitable network. That is, the plurality of user devices 2 may exchange data with each other through the virtual device network 2n regardless of which network is used to actually connect the user devices 2. At this time, the application executed in the user device 2 may be not aware of the network to which the user device 2 is actually connected.

Users 61, 62 may log in the communication server 1 through respective ones of the plurality of user devices 2, and register the user device 2 to the communication server 1. The communication server 1 performs authentication based on IDs of users 61, 62 when the user device 2 is registered. Once the user device 2 is registered to the communication server 1, automatic login may be performed when the user device 2 is connected to the communication server 1. The user device 2 transmits status information to the communication server 1 and thus may perform presence updating. One of the users 61 and 62 may generate the virtual device network 2n through the user device 2. The other one of the users 61 and 62 may participate in the virtual device network 2n created using the user device 2. The communication server 1 may create the virtual device network 2n based on the status information received from the user device 2 and may manage the participation in the virtual device network 2n.

The communication server 1 may transmit the status information from the user device 2 to the counterpart device 2. The user device 2 may show the status of the counterpart device 2 through a Graphic User Interface (GUI) based on the received status information. The communication server 1 may manage a list of previously created virtual device networks, and provide the list of the previously created virtual device networks to the user device 2. The user device 2 may request the communication server 1 for participating in a virtual device network 2n selected by the user 61, 62 from among the previously created virtual device networks included in the received list. One of the users 61, 62 who previously participated in the selected virtual device network 2n may accept or reject the request of the other of the users 61, 62 for the participation. The communication server 1 allocates and transmits virtual IPs to the respective user device 2 of the respective users 61 and 62 if the participation in the virtual device network is completed. Each of the plurality of user devices 2 uses the virtual IP to perform data transmission requested by the application. Each of the plurality of user devices 2 may perform data transmission by a P2P method first. If the data transmission based on the P2P method is difficult such that it is not performed or is performed poorly, the user device 2 may perform the data transmission through the relay server 5. The user device 2 receives information needed for the data transmission from the communication server 1. If the data transmission is completed, the user device 2 logs out from the communication server 1 according to a user's instruction.

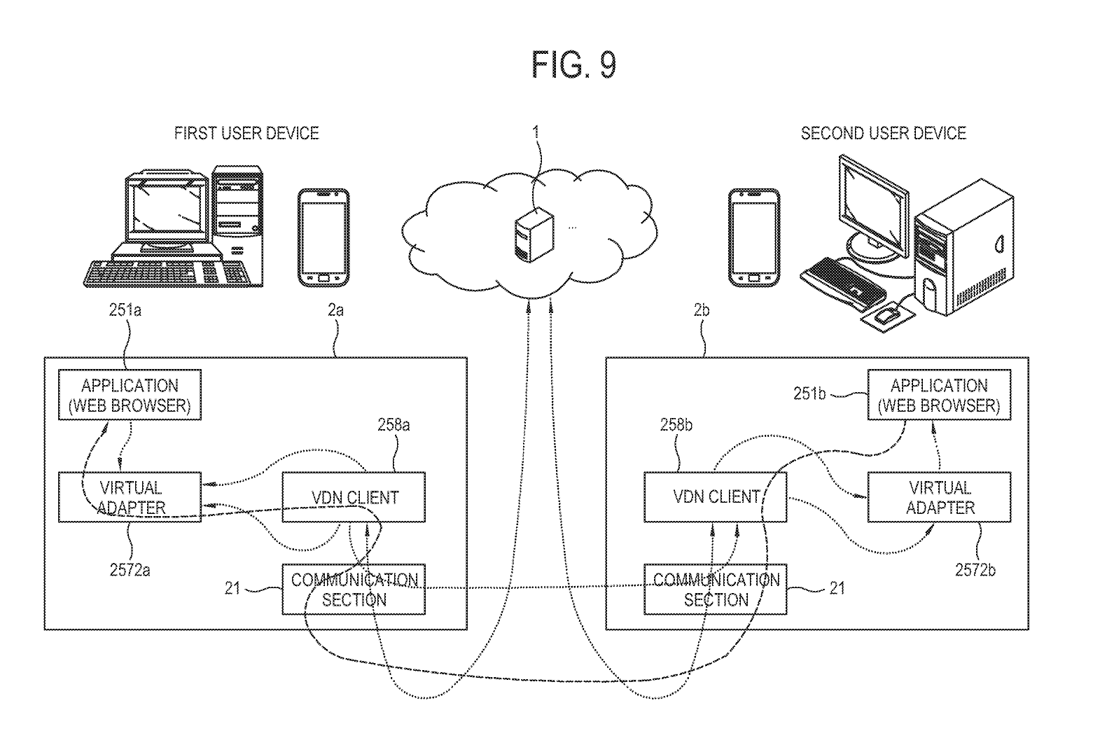

FIG. 9 illustrates detailed operations of a user device according to an exemplary embodiment of the present disclosure.

Referring to FIG. 9, operations illustrated will be described under conditions that a first user device 2a and a second user device 2b participate in the virtual device network. First, a VDN client 258a of the first user device 2a and a VDN client 258b of the second user device 2b log in the communication server 1 and participate in the virtual device network, thereby receiving and being allocated respective virtual IPs. For example, the VDN client 258a of the first user device 2a may be allocated a virtual IP of 23.0.0.1, and the VDN client 258b of the second user device 2b may be allocated a virtual IP of 23.0.0.2. The VDN clients 258a, 258b use their own received virtual IPs to set up virtual adapters 2572a and 2572b, respectively. For the virtual adapters 2572a and 2572b, technologies of network tunneling, a Traversal Utilities for NAT (TUN) device, or any other similar and/or suitable technology, system, device or method may be used by way of example.

The first user device 2a and the second user device 2b respectively execute applications 251a and 251b. For example, the application 251a of the first user device 2a may be a web browser, and the application 251b of the second user device 2b may also be a web server. The application 251a of the first user device 2a uses the virtual IP of the second user device 2b, which is 23.0.0.2 in the exemplary embodiment of FIG. 9, to try to transmit data through the virtual adapters 2572a, 2572b. For example, the application 251a of the web browser may transmit a packet for requesting data of a certain web page to the application 251b of the web server. The VDN client 258a of the first user device 2a monitors the attempt of the data transmission using the virtual IP 23.0.0.2 of the application 251a. In monitoring whether the application 251a uses the virtual IP 23.0.0.2 to attempt to transmit the data, a network tap technology may be used by way of example.

If it is determined that the application 251a attempts to transmit data through the virtual IP 23.0.0.2, then the VDN client 258a of the first user device 2a intercepts the request for the data transmission of the application 251a. The VDN client 258a of the first user device 2a attempts to connect with the second user device 2b based on information provided from the communication server 1. Each VDN client 258a, 258b first attempts the connection using the P2P method. The P2P method may, for example, employ technologies of UDP hole punching or Simple Traversal of UDP through NAT (STUN), which may also be referred to as Session Traversal Utilities for NAT (STUN).

Specifically, the VDN client 258a of the first user device 2a sends a UDP packet to the second user device 2 and determines whether interconnection is possible. In this case, the VDN client 258a of the first user device 2a may send the UDP packet to the second user device 2b through an actual IP address, hereinafter, referred to as an actual IP, provided by the communication server 1 and enabling actual communication with the second user device 2b. The actual IP of the second user device 2b is a typical IP address given to the second user device 2b through the communication section 21 of the second user device 2b. In this exemplary embodiment, the actual IP may, for example, include both an IP given from a Dynamic Host Configuration Protocol (DHCP) server in the case of the 3G network, and a dynamic IP given from an access point in the case of the Wi-Fi network. The communication server 1 manages information about the actual IPs of the user devices 2a, 2b participating in the virtual device network. The communication server 1 may transmit the actual IPs of a counterpart device, which may be either of the user device 2b and 2a, to the respective one of the user devices 2a and 2b if requested by the user devices 2a and 2b or the communication server 1 may transmit the actual IPs automatically, for example, when the virtual IP is transmitted. Meanwhile, with regard to the connection between the user devices 2a and 2b, port information may be previously determined in each VDN client 258a, 258b, or may be provided from the communication server 1.

Upon receiving the UDP packet received from the first user device 2a, the VDN client 258b of the second user device 2b transmits a responding UDP packet responding to the received UDP packet to the first user device 2a. The VDN client 258b of the second user device 2b may use the actual IP of the first user device 2a provided from the communication server 1 in order to transmit the responding UDP packet to the first user device 2a. The VDN client 258a of the first user device 2a determines that connection with the second user device 2b is possible if the responding UDP packet is received from the second user device 2b. If the responding UDP packet is not received from the second user device 2b, then the VDN client 258a of the first user device 2a determines that the connection with the second user device 2b is not possible. If the connection with the second user device 2b is not possible, then the VDN client 258a of the first user device 2a may transmit information about this to the communication server 1. The communication server 1 may transmit information, which indicates that the connection with the first user device 2a is not possible, to the second user device 2b. The respective VDN client 258a, 258b of the user devices 2a, 2b may inform users that they are not connectable, through the output section 23.

If the connection based on the P2P method is not allowed, then the VDN client 258a of the first user device 2a may perform a connection with the second user device 2b through the relay server 5. The first user device 2a requests a connection with the second user device 2b, the connection being through the relay server 5, to the communication server 1. The communication server 1 allows the first user device 2a and the second user device 2b to be connected to each other through the relay server 5.

When the user devices 2a and 2b are connected to each other, then the VDN client 258b of the second user device 2b generates the request for the data transmission from the application 251a of the first user device 2a to the virtual adapter 2572b. The application 251b of the second user device 2b receives the request for the data transmission from the application 251a of the first user device 2a through the virtual adapter 2572b.

For example, the application 251b of the second user device 2b transmits data of a requested web page to the first user device 2a in response to the request for the data transmission from the application 251a of the first user device 2a. The data transmission from the second user device 2b to the first user device 2a may be performed similarly as described above. The application 251a of the first user device 2a may provide a user with a web page based on data transmitted from the second user device 2b.

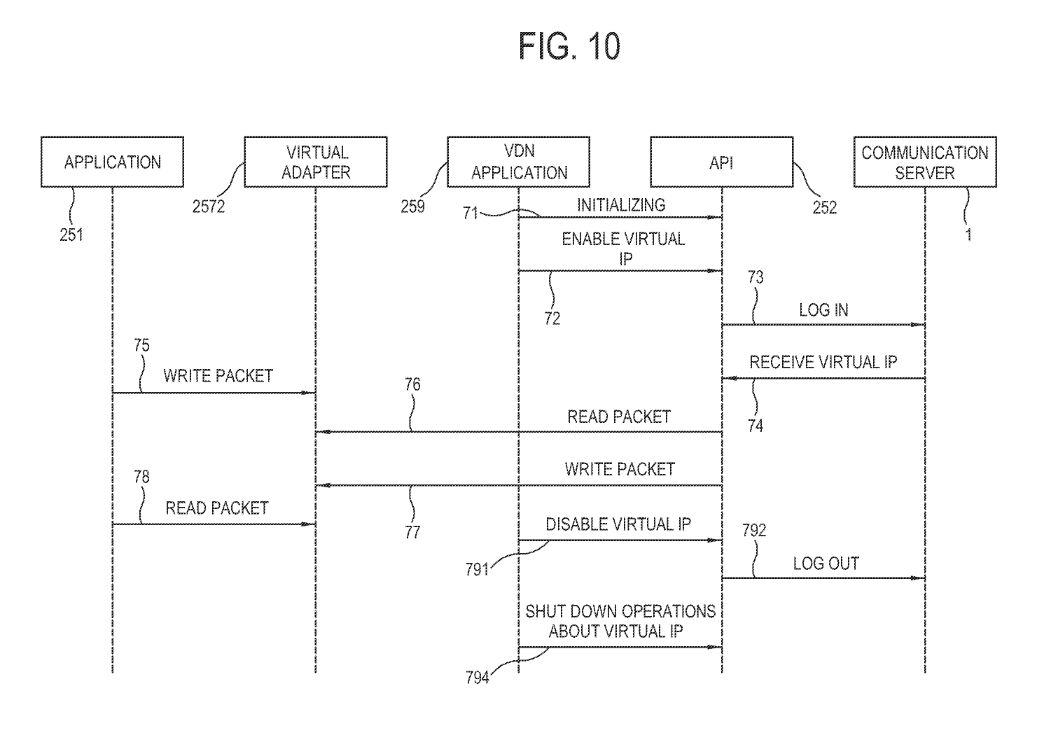

FIG. 10 illustrates operations of a VDN application and interactive operations between an application and a virtual adapter according to an exemplary embodiment of the present disclosure.

Referring to FIG. 10, a VDN application 259 uses an API 252 to invoke a function, for example, ‘vip_init( )’, thereby initializing a data structure related to the virtual IP in operation 71. For example, the VDN application 259 may perform bookkeeping, and check root permission. The VDN application 259 invokes a function, for example, ‘vip_enable( )’, thereby enabling the user device 2 to use the virtual IP in operation 72. For example, the VDN application 259 creates a virtual adapter 2572, performs the set-up for the virtual adapter 2572, and registers reading/writing functions. The API 252 may uses a function, for example, ‘login( )’, thereby logging into the communication server 1 in operation 73. The API 252 may receive the virtual IP from the communication server 1 in operation 74.

An application 251 may use a function, for example, ‘bsd socket( )’ and the virtual IP of the counterpart device 2 and thus, the application 251 writes a packet for data communication with the counterpart device 2 to the virtual adapter 2572 in operation 75. The API 252 reads the registered function, for example, ‘tun interface( )’ and thus reads the packet written to the virtual adapter 2572 by the application 251 in operation 76. On the other hand, the API 252 may use a function, for example, ‘tun interface( )’, and thus, the API 252 may write the packet for the data communication with the counterpart device 2 to the virtual adapter 2572 in operation 77. The application 251 uses a function, for example, ‘bsd socket( )’, to read the packet written in the virtual adapter 2572 in operation 78. That is, the VDN client 258 monitors the packet that is attempted to be transmitted through the virtual adapter 2572, and performs the data communication with the counterpart device 2 by using the P2P or relay method based on the information provided from the communication server 1 if there is the packet having the virtual IP of the counterpart device 2 as a target for the data transmission.

Meanwhile, the VDN application 259 may invoke a function, for example, ‘vip_disable( )’, and thus disable the user device 2 from using the virtual IP in operation 791. In this case, the virtual adapter 2572 may be deleted. Next, the API 252 invokes a function, for example, ‘logout( )’, thereby logging out from the communication server 1 in operation 792. Next, the VDN application 259 invokes a function, for example, ‘vip_shutdown( )’, and allows the user device to shut down the operations about the virtual IP in operation 794.

As described above, in the communication server 1 and the user device 2, according to exemplary embodiments discussed above, communication channels between the user devices 2 are remotely virtualized to thereby achieve the virtual device network.

According to an exemplary embodiment, without restriction to a subnet in which user devices belong, real-time remote communication between the user devices is enabled by the existing applications through the virtual device network.

While present disclosure has been shown and described with reference to certain exemplary embodiments thereof, it will be understood by those skilled in the art that various changes in form and details may be therein without departing from the spirit and scope of the invention as defined by the appended claims and their equivalents.

What is claimed is:

1. A control method of user devices, the method comprising:
registering the user devices to a communication server that provides a service of a virtual device network;
receiving a virtual Internet Protocol (IP) address of a counterpart device included in the virtual device network from the communication server;
determining whether an application attempts to perform data communication with the counterpart device using the virtual IP address; and
performing the data communication with the counterpart device according to information provided from the communication server if the application attempts to perform data communication with the counterpart device using the virtual IP address.

2. The method according to claim 1, further comprising transmitting status information of the user device to the communication server.

3. The method according to claim 1, further comprising receiving status information of the counterpart device from the communication server.

4. The method according to claim 1, further comprising requesting for creation of the virtual device network to the communication server.

5. The method according to claim 1, further comprising:
receiving a list of previously created virtual device networks from the communication server; and
requesting for participation in one of the previously created virtual device networks in the received list.

6. The method according to claim 1, wherein the performing of the data communication comprises performing data communication with the counterpart device through a Peer to Peer (P2P) method.

7. The method according to claim 1, wherein the performing the data communication comprises performing data communication with the counterpart device through a relay method.

8. A user device comprising:
a communication section communicating with a communication server that provides a service of a virtual device network;
a user input section receiving a user input of an instruction; and
a controller registering the user device to the communication server that provides the service of the virtual device network in accordance with a user's instruction, receives a virtual Internet Protocol (IP) address of a counterpart device included in the virtual device network from the communication server, determining whether an application attempts to perform data communication with the counterpart device through the virtual IP address, and performing the data communication with the counterpart device according to information provided from the communication server if the application attempts to perform data communication with the counterpart device using the virtual IP address.

9. The user device according to claim 8, wherein the controller controls status information of the user device to be transmitted to the communication server.

10. The user device according to claim 8, wherein the controller controls status information of the user device to be received from the communication server.

11. The user device according to claim 8, wherein the controller requests for creation of the virtual device network to the communication server.

12. The user device according to claim 8, wherein the controller receives a list of previously created virtual device networks from the communication server, and
wherein the controller requests for participation in one of the previously created virtual device networks in the received list.

13. The user device according to claim 8, wherein the controller controls data communication with the counterpart device to be performed through a Peer to Peer (P2P) method.

14. The user device according to claim 8, wherein the controller controls data communication with the counterpart device to be performed through a relay method.

15. A control method of a communication server, the method comprising:
registering a plurality of user devices with respect to a service of a virtual device network;
transmitting respective virtual Internet Protocol (IP) addresses of two or more user devices, which are to participate in the virtual device network, from among the plurality of registered user devices to the user devices; and
providing information for data communication between the two or more user devices.

16. The method according to claim 15, further comprising creating the virtual device network in accordance with a request of a user device, from among the plurality of user devices, that is to participate in the virtual device network.

17. The method according to claim 15, further comprising providing a list of previously created virtual device networks to the user device, from among the plurality of user devices, that is to participate in the virtual device network.

18. The method according to claim 15, further comprising:
receiving status information from one user device from among the plurality of registered user devices; and
providing the received status information to another user device from among the plurality of registered user devices.

19. A communication server comprising:
a communication section communicating with a plurality of user devices; and
a controller registering the plurality of user devices with respect to a service of a virtual device network, transmitting respective virtual Internet protocol (IP) addresses of two or more user devices, which are to participate in the virtual device network, from among the plurality of registered user devices to the user devices, and providing information for data transmission between the two or more user devices.

20. The communication server according to claim 19, wherein the controller controls the virtual device network to be created in accordance with a request of a user device, from among the plurality of user devices, that is to participate in the virtual device network.
